(19) United States
(12) Patent Application Publication
(10) Pub. No.: US 2011/0234794 A1
(43) Pub. Date: Sep. 29, 2011

(54) Uni-directional traffic monitoring system

(76) Inventors: Rongsheng Tian, Santa Clara, CA (US); Yong Tian, Cupertino, CA (US)

(21) Appl. No.: 13/065,637

(22) Filed: Mar. 25, 2011

Related U.S. Application Data
(60) Provisional application No. 61/135,538, filed on Mar. 26, 2010.

(51) Int. Cl. H04N 7/18; G08B 23/00

(52) U.S. Cl. 348/143; 340/573.1; 348/E07.085

(57) ABSTRACT

This invention discloses a traffic monitoring system, which uses Doppler sonar to measure the direction and speed of people and object moving within a target area, such as a secure one way exit. The system is un-obtrusive, accurate, and easy to operate. In case of unauthorized movement direction, the system triggers build-in alarms, as well as signals the integrated security and surveillance systems. The system consists of Head Modules, which are responsible for sending and receiving continuous ultra-sound wave at a pre-set direction of traffic and digital processing of the data; and Management Module, which is responsible for controlling the system, as well as interfacing with other surveillance and security systems.

### REFERENCE TO RELATED APPLICATIONS

The present application claims priority to the provisional Appl. Ser. No. 61/135,538 filed on Mar. 26, 2010, the entire content of which is hereby incorporated by reference.

### FIELD OF THE INVENTION

This invention generally relates to security surveillance systems and more specifically to the monitoring of secure entrances and exits. This invention offers an effective system to monitor the direction of traffic through entrances and exits, which alerts if a person or object moves in unauthorized direction. This system is inexpensive, fully automated, and easy to operate.

### BACKGROUND

Since the 9/11 terrorist attack, security level at public, government, and private buildings have increased. Dedicated passageways have been created for people entering and exiting the secure areas. For example, at the airport, all entering passengers must go through the metal detector and baggage scan; while the passengers leaving the airport go through a one way exit. To maintain the effectiveness of the security measure, the one way exit must be strictly enforced to ensure no breach.

At most buildings, including airport, the current system employs a combination of security agents, surveillance cameras, and physical barriers to keep unauthorized people from entering. The system works for most part, however, exit lane security breach may occur because of several factors, such as human error, i.e. during regular rotations or in case of emergency, the security agent may leave his/her station unattended. Unauthorized people may enter from the one-way exit passageway without being detected. While the surveillance cameras are good at catching unauthorized entries after the fact, but they cannot provide alarm during the violation. Additionally, the physical barriers are easy to evade for people determined to do so.

There have been a number of attempts at providing automated systems for monitoring the exit lane. Commercial vendors, such as Eagle Security Group, Inc. has provided double door and revolving door systems that forces people to move in single file toward one direction, however, at expense of the exit lane throughput. There are unobtrusive monitoring systems that do not reduce impact throughput. The earlier design uses two sets of photo-optic sensors mounted on a portal, the direction of a person passing through the portal is determined by which sensor is blocked first, as introduced in U.S. Pat. No. 6,507,278 to Brunetti et al. However, this design do not work well if there are close clustering of people moving through the portal, as the photo-optic sensors cannot distinguish blockage by each individual. More recent designs are based on video images of the one way exit area captured from surveillance cameras. The images are processed to identify individuals and their movement from frame to frame. The video can be from a single camera, as described in US Pat. Pub. No US 2007/0127774 to Zhang et al. or from stereo cameras, as described in US Pat. Pub. No US 2009/0237247 to Brunetti et al. Both systems require expensive computer hardware and software to process the video image data, and even then, the false positive rates can be high in case of large number of people on the one way exit.

There is a need for fully automated, accurate, and integrated system for monitoring of the one way passageways and immediate alerting in case of unauthorized entry.

### SUMMARY OF THE INVENTION

This invention discloses traffic monitoring system, which uses Doppler sonar to measure the direction and speed of people and object moving within a target area, such as a secure one way exit. In case of unauthorized movement direction, the system triggers build-in alarms, as well as signals the integrated security and surveillance systems.

### BRIEF DESCRIPTION OF THE DRAWINGS

FIG. 1 shows a Uni-directional Traffic Monitoring (UTM) installation for the exit lane.

FIG. 2 shows a block diagram of the UTM system.

FIG. 3 shows the detailed block diagram of the UTM Head Unit.

FIG. 4 shows UTM installation with an integrated security system.

### DETAILED DESCRIPTION OF THE INVENTION

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

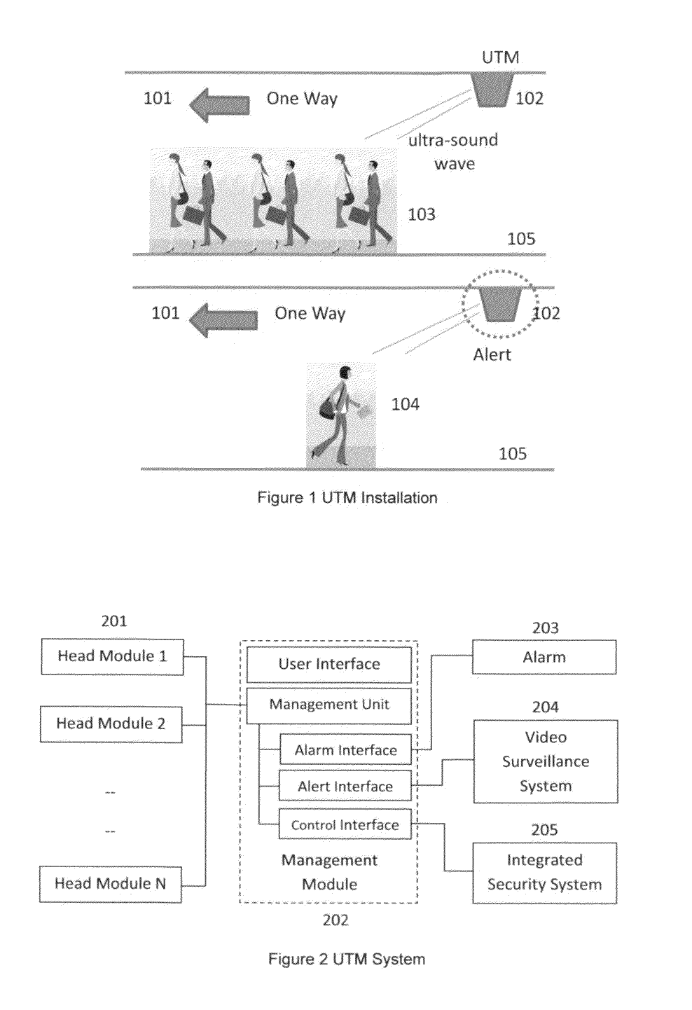

A typical Uni-directional Traffic Monitoring (UTM) installation is shown in FIG. 1. The UTM system 102 is mounted on the ceiling overlooking the one way passageway, such as an airport exit 101. A continuous ultra-sound wave is transmitted by the UTM toward the direction of authorized movement. The ultra-sound wave bounces back from people or object moving through the passageway. Due to Doppler Effect, if the person (or object) 103 is moving toward the UTM, the returned ultra-sound wave has higher frequency than the transmitted frequency. If the person (or object) 104 is moving away from UTM, the returned wave has lower frequency. The frequency difference between transmitted and returned ultra-sound wave is processed by UTM and used to identify the movement direction of people (or object) in the passageway. If there is movement in unauthorized direction, the UTM sends out an alert. In addition, the UTM can also measure the speed of movement in the passageway, based on the same Doppler Effect. If UTM detects faster than usual movements, it can also send out alerts. The UTM system consists of Head Module 201 and Management Module 202, as shown in FIG. 2. The Head Module's functions include generation and transmission of continuous ultra-sound wave at a pre-set frequency; reception of the ultra-sound wave back from traffic; and signal processing to filter out noise. Multiple head units may be needed to cover a wide area.

The Management Module includes Management Unit, User Interface, Alarm, Alert, and Control interfaces. The Management Unit is responsible for the overall operation of UTM. The User Interface allows user to set up alert conditions, parameters, and troubleshooting. The Alarm interface is used to control the UTM build in alarm or an external alarm 203. The UTM is capable of operating as a stand alone system, in conjunction with an existing video surveillance system 204, or as part of an integrated security system 205. In case of integration with video surveillance system, the Alert interface issues alert to the particular video monitoring video feeds with unauthorized movement. Each Management Module can control multiple head units installed at various places.

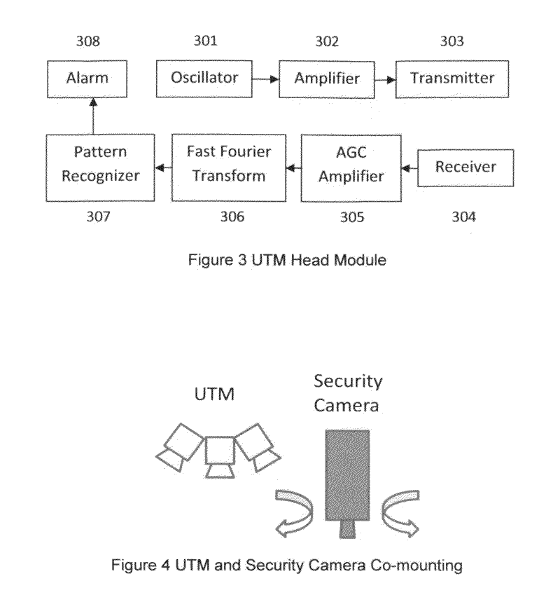

The Head Module is shown in more detail in FIG. 3. An oscillator 301 generates a continuous electric wave at a pre-set stable frequency. After amplification 302 the electric wave drives an ultra-sound transmitter 303. The ultra-sound wave is transmitted toward to the passageway. The return wave is received by receiver 304. An amplifier 305 with AGC (automatic gain control) is used to amplify and stabilize return signal. To remove noise caused by small movements attached to the main target body, such as arms and legs, the return signal is processed through a Fast Fourier Transform 305 and special pattern recognizer 306. The filtered signal is send to Alarm Manager 307 to detect any unauthorized movements.

As surveillance cameras are widely installed in secure areas, there is an existing infrastructure of power and signal cables. To ease the installation of UTM, the Head Module can be co-located with the cameras, sharing the same power supply and signal cable with the camera; while the Management Module can be co-located with the integrated security system in a command center. In addition, in the case of multiple Head Modules covering a wide area, the UTM can be used to identify general area of traffic direction violation or fast movement, and point the surveillance camera to better focus on the area, as shown in FIG. 4.

1. An Uni-directional Traffic Monitoring (UTM) system which uses Doppler sonar to monitor the people and/or object traffic in one-way passageway, and alert in case of unauthorized movement direction.

2. The UTM of claim 1, wherein the system also alert in case of faster or slower than usual people and/or objects movement in the monitored area.

3. The UTM of claim 1, wherein the system operates automatically and on a continuous basis.

4. The UTM of claim 1, wherein the system interfaces with integrated security and surveillance systems to alert unauthorized direction of movement in the monitored area.

5. The UTM of claim 1, wherein the system can be installed using the existing surveillance camera infrastructure.

6. The UTM of claim 1, wherein the system can direct surveillance camera to better focus on areas of traffic violation.

7. The UTM of claim 1, wherein the system can include a moving walkway on the passageway to increase the system reliability.
